(19) United States
(12) Patent Application Publication
(10) Pub. No.: US 2017/0262296 A1
(43) Pub. Date: Sep. 14, 2017

(54) ELECTRONIC APPARATUS AND CONTROLLING METHOD THEREOF

(71) Applicant: SAMSUNG ELECTRONICS CO., LTD., Suwon-si (KR)

(72) Inventors: Jong-soo SOHN, Suwon-si (KR); Dae-won SEO, Suwon-si (KR); Ji-hyoung SON, Seoul (KR); Sang-hee LEE, Yongin-si (KR); Se-jung CHANG, Suwon-si (KR)

(21) Appl. No.: 15/371,810

(22) Filed: Dec. 7, 2016

(30) Foreign Application Priority Data
Mar. 11, 2016 (KR) 10-2016-0029624

(51) Int. Cl. G06F 9/44; H04L 12/24; H04L 29/08

(52) U.S. Cl. CPC G06F 9/4446; H04L 67/16; H04L 41/22; H04L 67/34

(57) ABSTRACT

An electronic apparatus is provided. The electronic apparatus includes a communicator comprising communication circuitry configured to communicate with an external server, a storage configured to store a plurality of management applications to manage a service application which provides a certain service and a common application performing a pre-processing function required to execute the service application, a display configured to display a user interface (UI) provided by a first management application among the plurality of management applications, and a processor configured to control the communication circuitry, in response to a command to execute a first service application managed by the first management application being input, to receive information regarding a pre-processing procedure required to execute the first service application in an operating system of the electronic apparatus from the external server using the common application, to perform a pre-processing function required to execute the first service application based on the received information on the pre-processing procedure, and to control the display to display a UI provided by the first service application of which the pre-processing function is completed.

### CROSS-REFERENCE TO RELATED APPLICATION

This application is based on and claims priority under 35 U.S.C. §119 to Korean Patent Application No. 10-2016-0029624, filed in the Korean Intellectual Property Office on Mar. 11, 2016, the disclosure of which is incorporated by reference herein in its entirety.

### BACKGROUND

1. Field

The present disclosure relates generally to an electronic apparatus and controlling method thereof, and for example to an electronic apparatus capable of performing a series of processes for executing an application and a controlling method thereof

2. Description of Related Art

Thanks to the electronic technology development, an electronic apparatus can be connected to a network through a communications network and various contents can be provided to a user through the network. These days, various applications can be installed in an electronic apparatus such as a smartphone, a smart TV or the like, and a user installs and uses various applications that he/she needs.

In prior art, in order to execute an application, a series of steps, namely a pre-processing procedure is required and in an electronic apparatus, a pre-processing procedure should be performed for each application. For example, if there are two or more application stores (an application store is an application which provides a service of downloading a new application) in an electronic apparatus, the two or more application stores individually perform a process for executing an application.

Since a step processing function to execute an application should be implemented for each application store in prior art, there is an inefficiency of repetitive developments. In addition, since there is a possibility for an application developer to miss a step while implementing the step processing function, there may be an inconsistency in user scenarios of two or more than two application stores.

### SUMMARY

Methods and apparatuses of the present disclosure relate generally to an electronic apparatus capable of processing a series of steps for executing an application and a controlling method thereof.

According to an example embodiment, an electronic apparatus is provided, including: a communicator comprising communication circuitry configured to communicate with an external server; a storage configured to store a plurality of management applications to manage a service application which provides a certain service and a common application performing a pre-processing function required to execute the service application; a display configured to display a user interface (UI) provided by a first management application among the plurality of management applications; and a processor configured to control the communication circuitry, in response to a command to execute a first service application managed by the first management application being input, to receive information regarding a pre-processing procedure required to execute the first service application in an operating system of the electronic apparatus from the external server using the common application, to perform a pre-processing function required to execute the first service application based on the received information on the pre-processing procedure, and to control the display to display a UI provided by the first service application of which the pre-processing function is completed.

The processor may, in response to a command to execute a second service application managed by a second management application among the plurality of management applications being input, execute a pre-processing function required to execute the second service application by using the common application.

The plurality of management applications may not include a service engine performing the pre-processing function.

The plurality of management applications may respectively be an application which performs at least one of a function of downloading a new application and a function of executing another application in the application.

The pre-processing function may be at least one of a function of checking whether terms of use of a new application are agreed, a function of checking whether the first service application is installed in the electronic apparatus, a function of checking whether a user is logged into an account, a function of checking whether payment for the first service application is completed, a function of checking whether an adult authentication is completed for the first service application and a function of checking whether the first service application using a function of the electronic apparatus is agreed.

The processor may check whether a condition for executing the first service application is satisfied by performing a pre-processing function by using the common application and control the display to display a UI according to an unsatisfied condition.

The processor may, in response to the first service application being unable to be executed due to a failure of performing the pre-processing function, control the display to display a guide UI for trying the first service application execution again by using the common application.

The storage may store a plurality of operational programs corresponding to a plurality of operating systems, and the processor may determine one of the plurality of operating systems as an operating system to be driven in the electronic apparatus according to a manipulation of a user.

The processor may, in response to a command to execute the first service application being input in the determined operating system, control the communicator to receive information regarding a pre-processing procedure required to drive the first service application in the determined operating system from the external server.

The processor may separately execute the first management application and the common application.

The processor may, in response to a command to execute the first service application being input through a UI provided by the first management application, execute the common application.

According to an aspect of another example embodiment, a method of controlling an electronic apparatus storing a plurality of management applications to manage a service application which provides a certain service and a common application performing a pre-processing function required to execute the service application, is provided, the method including: receiving information regarding a pre-processing procedure required to execute a first service application in an operating system of the electronic apparatus from an external server using a common application in response to a command to execute the first service application managed by the first management application being input among the plurality of management applications; performing a pre-processing function required to execute the first service application using the common application based on the received information on the pre-processing procedure; and displaying a UI provided by the first service application of which the pre-processing function is completed.

The method may further include, executing a pre-processing function required to execute a second service application using the common application in response to a command to execute the second service application managed by a second management application among the plurality of management applications being input.

The performing a pre-processing function may include checking whether a condition for executing the first service application is satisfied by performing a pre-processing function by using the common application and displaying a UI according to an unsatisfied condition.

The method according to another example embodiment may further include displaying a guide UI for trying the first service application execution again using the common application, in response to the first service application being unable to be executed due to a failure of performing the pre-processing function.

The method may further include; the electronic apparatus storing a plurality of operational programs corresponding to a plurality of operating systems, and determining one of the plurality of operating systems as an operating system to be driven in the electronic apparatus according to a manipulation of a user.

The receiving may include, in response to a command to execute the first service application being input in the determined operating system, receiving information regarding a pre-processing procedure required to drive the first service application in the determined operating system from the external server.

The first management application and the common application may be separately executed.

The method may further include: displaying a UI provided by the first management application; and in response to a command to execute the first service application being input through the UI, executing the common application.

According to an aspect of another example embodiment, a computer-readable recording medium is provided including a program to execute a method of controlling an electronic apparatus storing a plurality of management applications to manage a service application which provides a certain service and a common application performing a pre-processing function required to execute the service application, the method includes receiving information regarding a pre-processing procedure required to execute the first service application in an operating system of the electronic apparatus from an external server using the common application: in response to a command to execute a first service application managed by the first management application being input among the plurality of management applications; performing a pre-processing function required to execute the first service application by using the common application based on the received information on the pre-processing procedure; and displaying a UI provided by the first service application of which the pre-processing function is completed.

### BRIEF DESCRIPTION OF THE DRAWINGS

The above and other aspects, features and attendant advantages of the disclosure will become more readily apparent from the following detailed description, taken in conjunction with the accompanying drawings, in which like reference numerals refer to like elements, and wherein:

FIG. 1 is a block diagram illustrating an example configuration of an electronic apparatus according to an example embodiment;

FIG. 2 is a diagram illustrating an example procedure of performing a pre-processing function for executing an application according to an example embodiment;

FIG. 3 is a flowchart illustrating example operations of an electronic apparatus and an external server according to an example embodiment;

FIG. 4 is a diagram illustrating an example common application of an electronic apparatus according to an example embodiment; and

FIG. 5 is a flowchart illustrating an example method of controlling an electronic apparatus according to an example embodiment.

### DETAILED DESCRIPTION

Hereinafter, the terms used in the description will be described briefly, and example embodiments will be described in greater detail with reference to the accompanying drawings.

With respect to the terms used in an example embodiment of the disclosure, general terms currently and widely used are selected in view of function with respect to the disclosure. However, the terms may vary according to an intention of a technician practicing in the pertinent art, an advent of new technology, etc. In specific cases, terms may be chosen arbitrarily, and definitions thereof will be described in the description of the corresponding disclosure. Accordingly, the terms used in the description should not necessarily be construed as simple names of the terms, but be defined based on meanings of the terms and overall contents of the present disclosure.

The example embodiments may vary, and may be provided in different example embodiments. Various example embodiments will be described with reference to accompanying drawings. However, this does not necessarily limit the scope of the example embodiments to a specific embodiment form. Instead, modifications, equivalents and replacements included in the disclosed concept and technical scope of this description may be employed. While describing example embodiments, if it is determined that the description regarding a known technology obscures the gist of the invention, a detailed description thereof may be omitted.

The term such as “first” “second”, and so on may be used to explain a variety of elements, but the elements should not be limited thereto. The terms are used to distinguish one entity from another entity, without necessarily implying any actual relationship or order between such entities.

A singular term includes a plural form unless otherwise indicated. The terms, “include,” “comprise,” “is configured to,” etc. of the description are used to indicate the existence of features, numbers, steps, operations, elements, parts or combination thereof, and do not exclude the possibilities of combination or addition of one or more features, numbers, steps, operations, elements, parts or combination thereof.

In an example embodiment, ‘a module’ or ‘a unit’ performs at least one function or operation, and may be realized as hardware (e.g., circuitry), software, or combination thereof. Further, except the “modules” or “units” that have to be implemented by certain hardware, a plurality of “modules” or a plurality of “units” may be integrated into at least one module and realized as at least one processor (not illustrated).

In an example embodiment, where a part is “connected” to another part, the case also includes a case where the part is “electrically connected” to the other part with another element interposed therebetween.

Hereinafter, the example embodiments will be described in greater detail in a manner that will be understood by one of ordinary skill in the art. The example embodiments may be implemented by various forms, and are not limited to the example embodiments described herein.

Hereinafter, the present disclosure will be described in greater detail with reference to the accompanying drawings.

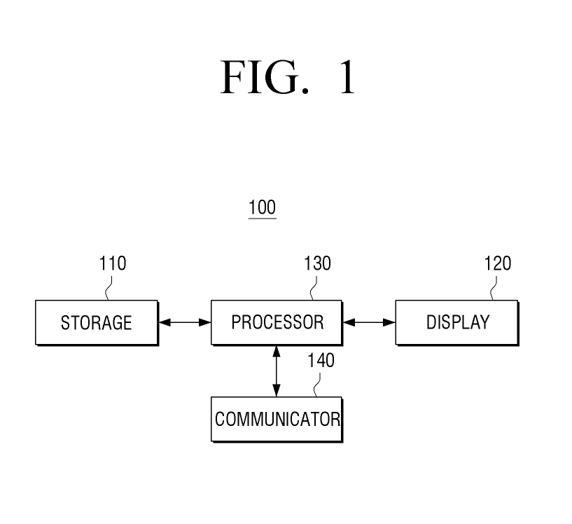

FIG. 1 is a block diagram illustrating an example configuration of an electronic apparatus according to an example embodiment.

FIG. 1 illustrates an electronic apparatus 100 including a storage 110, a display 120, a processor (e.g., including processing circuitry) 130 and a communicator (e.g., including communication circuitry) 140. The electronic apparatus 100 may be a smartphone, a lap top computer, a portable multimedia player (PMP), an MP3 player, a smart TV, a desktop computer or a wearable apparatus, or the like, but is not limited thereto.

The storage 110 may store various programs and data required to operate the electronic apparatus 100. The storage 110 may be embodied as a non-volatile memory, a volatile memory, a flash-memory, a hard disk drive (HDD), a solid state drive (SSD) or the like. The storage 110 access by the processor 130 and the processor 130 may read, record, change, delete and update data. The term “storage” in the disclosure may include the storage 110, a ROM (not illustrated) or a RAM (not illustrated) in the controller 130, or a memory card (not illustrated) which is equipped with the electronic apparatus 100 (for example, a micro SD card or a memory stick).

For example, the storage 110 may store a program which is a set of various commands required to drive the electronic apparatus 100. The storage 110 may store a program and data to compose various screens which are to be displayed on the display 120. Herein, the program may include an operating program to execute an application in addition to an application (or an application program) to provide a certain service. The storage 110 may store a plurality of operating programs corresponding to a plurality of operating systems. For example, a plurality of operating systems may include a first operating system and a second operating system, the first operating system may be an Android operating system, and the second operating system may be an iOS operating system. Meanwhile, even though only the Android operating system and the iOS operating system are mentioned, it is obvious that various operating systems such as a window operating system, a Tizen operating system and the like can be applied. According to a manipulation of a user, the electronic apparatus 100 may be driven in one of the plurality of operating systems.

The storage 110 may store a plurality of management applications that manage a service application providing a certain service and a common application performing a pre-processing function required to execute the service application.

The management application may be an application that performs at least one of a function of downloading a new application and a function of executing another application in the management application.

An application which provides an application store service may be an example of the management application. For example, “Google Play” of the Android operating system, “App Store” of the iOS operating system, “APPS” or “GAMES” of the Tizen operating system may be the management application.

In addition, any application capable of executing another application in the application may be the management application. For example, if an application can be executed when the application's icon is displayed on a UI provided by a certain application and the icon is selected, the certain application may be the management application. As an example, Facebook® application may be the management application because the messenger application of Facebook® can be directly executed in the Facebook application.

The service application may refer, for example, to any application which can be executed by such a management application. For example, any application that can be downloaded in “Google Play” may be a service application, and the messenger application of Facebook may be the service application in the above example.

The common application may refer, for example, to an application which can perform a pre-processing function required to execute an application. For example, the pre-processing function required to execute an application indicates a series of processes including, when an application to be executed is a subscription-based application, checking whether payment is completed, providing a UI for payment to a user if the payment is not completed and finally executing the application to be executed.

The management application in the electronic apparatus 100 where the common application is installed does not include a service engine which performs the pre-processing function. Even though the management application includes the service engine which performs the pre-processing function, if the common application is installed, the service engine included in the management application is not driven and the pre-processing function may be performed only by the common application. Therefore, the pre-processing function required to execute the application may be performed only by the common application.

The display 120 may refer, for example, to an element for displaying various displays under control of the processor 130.

For example, the display 120 may be embodied as a liquid crystal display (LCD) and according to a situation, the display 120 may be embodied as a cathode-ray tube (CRT), a plasma display panel (PDP), organic light emitting diodes (OLED), transparent OLED (TOLED) or the like, but is not limited thereto. In addition, the display 120 may be embodied as a touch screen which can detect a touch operation of a user.

For example, the display 120 may display a UI provided by an application such as the management application, the service application or the like.

In addition, the display 120 may display various UIs required in performing a pre-processing function required to execute the service application by using the common application. For example, various UIs may be displayed on the display 120 in the process of performing the pre-processing function such as a UI through which terms of use of a new application is agreed, a UI through which the service application is installed in the electronic apparatus 100, a UI through which a user is logged in an account, a UI through which payment for the service application is completed, a UI through which an adult authentication is completed for the service application use, a UI through which the service application using a function of the electronic apparatus 100 is agreed and the like.

The processor 130 may include various processing circuitry configured to control overall operation of the electronic apparatus 100. For example, the processor 130 controls overall operation of the electronic apparatus 100 by using various programs stored in the storage 110.

For example, the processor 130 may include various processing circuitry, such as, for example, and without limitation, a central processing unit (CPU), a RAM, a ROM and a system bus. The CPU decodes a command, executes an arithmetic and logic operation or processes data. Specifically, the CPU may generate image data. Meanwhile, when the electronic apparatus 100 can be driven in a plurality of operating systems, the CPU may generate image data for each of the operating systems. Even though it is explained that the CPU generates image data in the example embodiment, the electronic apparatus 100 may include a graphic processor which exclusively generates image data when the disclosure is embodied.

Hereinabove, it is explained that the processor 130 includes one CPU but the processor 130 is not limited thereto and may be embodied with a plurality of CPUs (or digital signal processors (DSPs), System on Chips (SoCs) or the like).

When the electronic apparatus 100 is booted, the processor 130 may control the display 120 to display UI objects regarding various applications which are installed in the electronic apparatus 100. For example, the processor 130 may control the display 120 to display icons respectively corresponding to applications for receiving a command to execute an application.

For example, when a command to drive a service application managed by a management application is input, the processor 130 may perform a pre-processing function required to execute the service application by using a common application.

The command to execute the service application can be input through a UI provided by the management application. As a specific example, the management application may display an icon of the service application. When a user selects an icon, a command to execute a service application corresponding to the selected icon is input. For example, if a user selects an icon of a first service application to download the new first service application in a management application providing an application store service, a command to execute the first service application is input, and according to the execution command, the processor 130 may perform a pre-processing function required to execute the first service application by using the common application.

The pre-processing function may include at least one of a function of checking whether terms of use of a new application is agreed, a function of checking whether the first service application is installed in the electronic apparatus 100, a function of checking whether a user is logged into an account, a function of checking whether payment for the first service application is completed, a function of checking whether an adult authentication is completed for the first service application and a function of checking whether the first service application using a function of the electronic apparatus is agreed.

The processor 130 may receive an input of a command to execute a plurality of respective service applications managed by a plurality of different management applications and perform a pre-processing function required to execute each of the plurality of service applications.

For example, when a command to execute a first service application managed by a first management application is input, the processor 130 may perform a pre-processing function required to execute the first service application by using a common application, and when a command to execute a second service application managed by a second management application is input, the processor 130 may perform a pre-processing function required to execute the second service application by using the common application.

In addition, processor 130 may check whether a condition to execute a service application to be executed is satisfied by performing a pre-processing function by using the common application and control the display 120 to display a UI according to an unsatisfied condition.

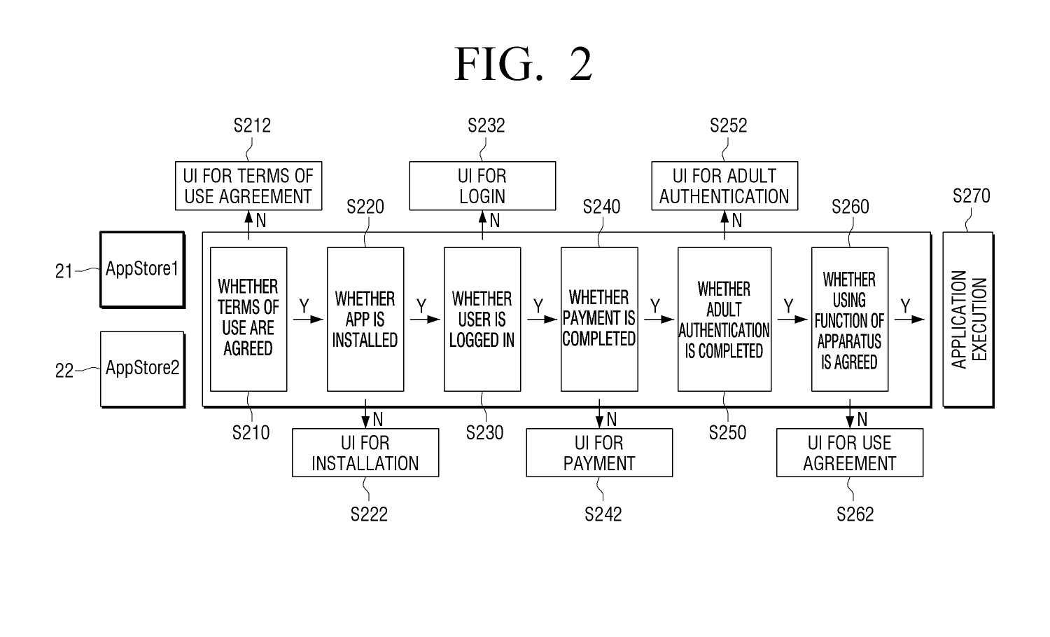

Hereinafter, such a pre-processing function will be explained in greater detail with reference to FIG. 2.

FIG. 2 is a diagram illustrating an example procedure of performing a pre-processing function according to an example embodiment.

Referring to FIG. 2, when a command to execute a first service application managed by an application store, e.g., ‘AppStore1’ 21 which is a management application stored in the storage 110 is input, the processor 130 performs a pre-processing function required to execute the first service application by using a common application 23.

For example, the processor 130 first checks whether terms of use of a new application in the electronic apparatus 100 are agreed (S210). In other words, it is checked if a user agreed with a configuration change of a program in the electronic apparatus 100 by the new application being installed in the electronic apparatus 100.

If the terms of use are not agreed, the processor 130 controls the display 120 to display a UI for the terms of use agreement in using the new application (S212).

If the terms of use were agreed or a selection indicating that the user agrees with the terms of use is input through the UI for the terms of use agreement in using the new application, the processor 130 checks whether the first service application to be executed is installed in the electronic apparatus 100 (S220).

If the first service application is not installed in the electronic apparatus 100, the processor 130 controls the display 120 to display a UI for installing the first service application in the electronic apparatus 100 (S222).

If the first service application was installed in the electronic apparatus 100 or a user inputs a command to install the first service application through the UI for installation, the processor 130 determines whether the first service application is an application which can be used when the user is logged in an account. If the application does not require a login, the next step is processed. If the application requires a login, whether a user is logged in an account is checked (S230).

If the user is logged into the account, the next step is processed and if the user is not logged into the account, the processor 130 controls the display 120 to display a UI for the user to log in the account (S232). The user may input an ID and passwords, and if the user does not have any account, a command to generate a new account may be input through the login UI.

If the first service application is an application which does not require a user to log in an account, a user already has been logged into an account of an application which requires a login, or a user is logged into an account through the login UI, the processor 130 checks whether the first service application is a subscription-based application. If the first service application is free, the next step is processed. If the first service application is a subscription-based application, the processor 130 checks if payment for the first service application is completed (S240).

If payment for the first service application is not completed, the processor 130 controls the display 120 to display a UI for purchasing the first service application (S242).

If the first service application is a free application, or if the first service application is a subscription-based application which has already been purchased, or when a user purchases the first service application through the payment UI, the processor 130 determines whether an adult authentication is required for the first service application. If the first service application is an application which does not require an adult authentication, the processor 130 processes the next step. If the first service application is an application which requires an adult authentication, the processor 130 checks whether an adult authentication for the first service application is completed (S250).

If the adult authentication for the first service application is not completed, the processor 130 controls the display 120 to display a UI for an adult authentication to use the first service application (S252).

If the first service application is an application which does not require an adult authentication, or if the first service application requires an adult authentication which has already been completed, or if a user completes the adult authentication through the UI for adult authentication, the processor 130 checks whether the first service application using a function of the electronic apparatus 100 is agreed (S260).

If the first service application using a function of the electronic apparatus 100 is not agreed, the processor 130 controls the display 120 to display a UI for an agreement in the first service application using a function of the electronic apparatus 100 (S262).

If it was agreed for the first service application to use a function of the electronic apparatus 100 or if a user agrees through the UI for the use agreement, the processor 130 executes the first service application (S270). In other words, the processor 130 may control the display 120 to display a UI provided by the first service application of which a pre-processing function is completed. Herein, the UI provided by the first service application is an execution screen of the first service application.

Meanwhile, the procedure of performing the pre-processing function explained with reference to FIG. 2 only pertains to an example. According to an attribute of an application to be executed and an operating system on which the application runs, conditions required to execute the application and orders to determine the conditions may differ. Therefore, in the procedure of determining conditions such as whether terms of use are agreed, whether an application is installed, whether an account is logged in, whether payment for an application is completed, whether an adult authentication is succeeded and the like, a determination order may be changed and a condition may be omitted and/or another condition may be added in the procedure.

Meanwhile, if the first service application cannot be executed due to a failure in performing the pre-processing function, the processor 130 may control the display 120 to display a guide UI for trying the first service application execution again by using the common application. A user may input a command to try the first service application execution again through the guide UI. Then, the processor 130 may perform the pre-processing function again.

Meanwhile, even when a command to execute a second service application managed by ‘AppStore2’ 22 which is a second management application is input, the processor 130 may perform a series of pre-processing function required to execute the second service application by using the common application 23 in the same way as the above description.

As described the above, the processor 130 may check whether a condition for executing a service application to be executed is satisfied by performing a pre-processing function by using the common application and control the display to display a UI (for example, the UI for terms of a use agreement of S212, the UI for an installation of S222, the UI for a login of S232, the UI for payment of S242, the UI for an adult authentication of S252 or the UI for a use agreement of S262) according to an unsatisfied condition.

Since the common application can perform a pre-processing function for executing a service application in different operating systems or when managed by different management applications en bloc, each of the management applications is not required to have algorithm to perform the pre-processing function. Conventionally, since a first management application should include algorithm for performing a pre-processing function according to an operating system and a second management application should include algorithm for performing a separate pre-processing function, there is an inefficiency that algorithm for a separate pre-processing function for each management application should be developed. However, according to the disclosure, the inefficiency can be resolved. In addition, conventionally, there is a possibility that a developer accidentally develops a pre-processing function of a first management application and a pre-processing function of a second management application to be performed differently, or any pre-processing step is omitted. However, with a common application which performs a pre-processing function as described in the disclosure, pre-processing procedure consistency may be secured and omitting any pre-processing step may be avoided. Therefore, a malfunction when an application is executed may be avoided as well.

Meanwhile, different pre-processing functions may be required for executing different applications according to an operating system. Therefore, when a command for executing an application is input, the processor 130 may figure out an operating system in which the electronic apparatus 100 is driven and process a pre-processing function required for executing the application in the operating system by the common application.

For example, the processor 130 may request for information regarding a pre-processing procedure to be performed in the operating system in which the electronic apparatus 100 is driven to an external server through the communicator 140 and receive the information, and based on the received information, the processor 130 may perform a pre-processing function by using the common application.

The information regarding the pre-processing procedure indicates information regarding at least one of conditions to execute a certain application in a certain operating system. For example, the information regarding the pre-processing procedure may include information which informs that in order for a certain application to be executed, a login, a terms of use agreement and an adult authentication are required and a pre-processing procedure should be performed in the order of a login, a terms of use agreement and an adult authentication.

The communicator 140 includes various communication circuitry configured to communicate with various external apparatuses. The communicator 140 may request for information regarding a pre-processing procedure by communicating with an external server and receive the information. For example, the communicator 140 may access an external apparatus through a local area network (LAN), the Internet network, a wireless method (for example, the wireless communications methods such as GSM, UMTS, LTE, WiBRO and the like).

When a command to execute a certain service application managed by a certain management application is input, the processor 130 may control the communicator 140 to receive information regarding a pre-processing procedure required to execute the certain service application in an operating system of the electronic apparatus 100 from an external server.

For example, the processor 130 may transmit information regarding the certain service application and information regarding the operating system of the electronic apparatus 100 to the external server and receive the information regarding the pre-processing procedure through the communicator 140.

According to an example embodiment, the electronic apparatus 100 may operate in a plurality of operating systems. In other words, the electronic apparatus 100 may be equipped with a plurality of operating systems. For example, the electronic apparatus 100 may be equipped with dual operating systems (Dual OSs). In this example, the processor 130 may determine an operating system to be driven according to a user control. For example, in response to a pre-determined user manipulation being input while a first operating system is being driven, the processor 130 may convert from the first operating system to a second operating system.

In this example, when a command to execute the certain application is input in the operating system determined according to a user manipulation, the processor 130 may control the communicator 140 to transmit information regarding the certain service application to the external server together with the information regarding the determined operating system.

For example, if the electronic apparatus 100 can be driven in one of the Android operating system and the Window operating system according to a user manipulation and a command to execute Application A is input in the condition that the Android operating system is determined as the operating system of the electronic apparatus 100 according to the user manipulation, the processor 130 may control the communicator 140 to request for information regarding a pre-processing procedure required to execute Application A in the Android operating system to an external server and receive the information.

The external server stores information regarding a pre-processing procedure required to execute each application in a certain operating system.

When a request for the pre-processing procedure is received from the electronic apparatus 100, the external server may transmit information regarding the pre-processing procedure which should be performed in order to execute a certain application in the electronic apparatus 100, to the electronic apparatus 100.

Even though it is explained that the electronic apparatus 100 receives information regarding the pre-processing procedure from the external server in the above example embodiment, the information may be stored in the electronic apparatus 100 in advance. In other words, it is not necessary to request for information regarding a pre-processing procedure to the external server whenever a command to execute an application is input, and if information regarding the pre-processing procedure requested to and received from the external server was stored in the storage 110 in advance, the information may be used.

The processor 130 may perform a pre-processing function required to execute a certain service application by using a common application based on the received information or the information regarding the pre-stored pre-processing procedure.

The electronic apparatus 100 may further include an inputter (not illustrated). The inputter comprises various input circuitry configured to receive a user control command and, may include, for example, and without limitation, a physical button, a touch screen with the display 120, or the like, but is not limited thereto. For example, the input circuitry of the inputter may include various input circuitry, such as, for example, and without limitation, a keyboard, a mouse and the like. The inputter may include various circuitry (for example, an IR signal receiving apparatus) configured to receive a control signal from a remote controller (not illustrated) to control the electronic apparatus 100.

A user may input various commands through the inputter of the electronic apparatus 100. For example, the user may input a command to execute a certain application through the inputter and input a command to convert an operating system of the electronic apparatus 100.

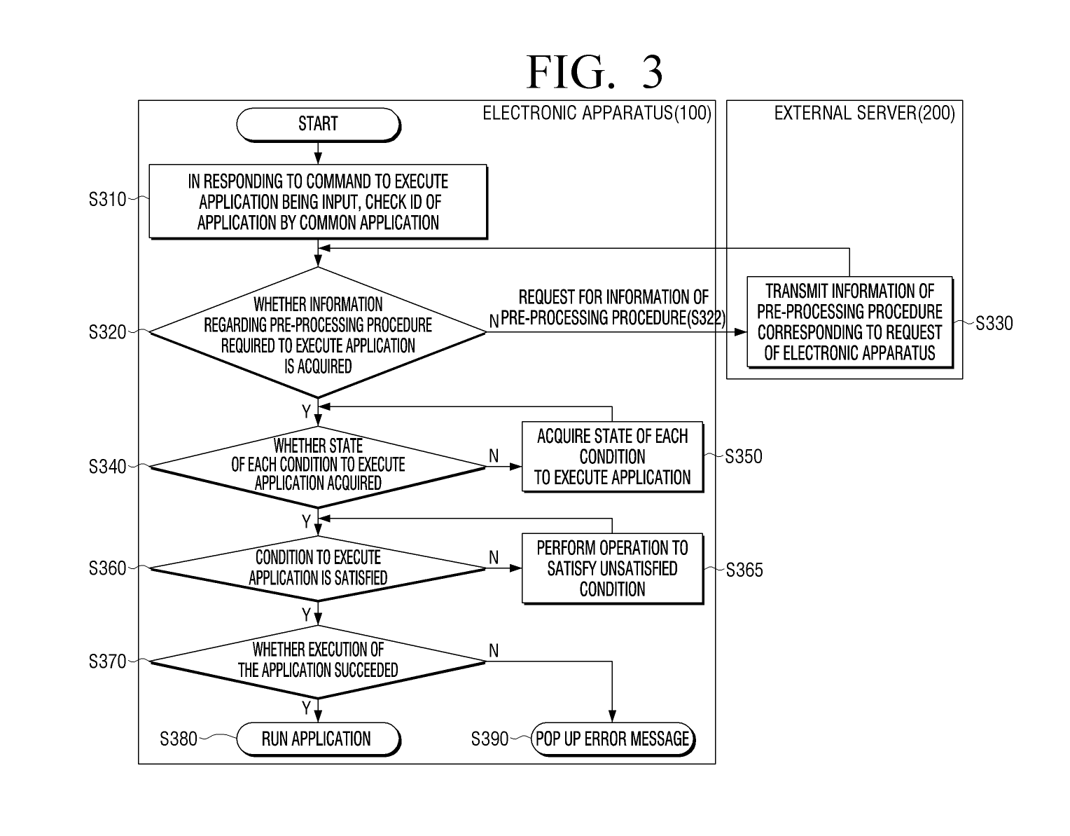

FIG. 3 is a flowchart illustrating example operations of the electronic apparatus 100 and the external server according to an example embodiment.

Referring to FIG. 3, when a command to execute a certain service application (APP) managed by a certain management application is input, the processor 130 checks an application ID of the service application using a common application (S310). The application ID indicates unique identification information which is assigned to each application.

The processor 130 checks whether information regarding a pre-processing procedure required to execute the service application is acquired by using the common application (S320), and if the information is not acquired, the processor 130 requests for the information to an external server by using the common application (S322). In this example, the processor 130 may request for information regarding a pre-processing procedure by transmitting an application ID of the service application and information regarding the electronic apparatus 100 to the external server 200. The information regarding the electronic apparatus 100 may include information regarding an operating system of the electronic apparatus 100.

The external server 200 may receive the request and transmit information regarding the pre-processing procedure according thereto, to the electronic apparatus 100 (S330). For example, based on the application ID and the information regarding the operating system of the electronic apparatus 100 received from the electronic apparatus 100, the external server 200 searches for information regarding a pre-processing procedure to execute an application corresponding to the application ID in the current operating system of the electronic apparatus 100 from data of the external server 200 and transmits the information to the electronic apparatus 100.

By receiving the information regarding the pre-processing procedure from the external server 200, the electronic apparatus 100 may acquire the information regarding the pre-processing procedure of the service application to be executed. Alternatively, if the information regarding the pre-processing procedure is pre-stored in the storage 110, an operation of requesting to the external server 200 may be omitted.

If it is determined that the information regarding the pre-processing procedure is acquired from the external server 200 (S320,Y), the processor 130 checks whether a state for each of at least one condition to execute the service application is acquired by using the common application based on the acquired information regarding the pre-processing procedure (S340). For example, based on the information regarding the pre-processing procedure, if required conditions to execute the service application in the current operating system of the electronic apparatus 100 are an adult authentication and the application purchase, the processor 130 determines whether information regarding the conditions which are whether an adult authentication is completed and whether the application is purchased is acquired by using the common application.

If the state is not acquired, the processor 130 requests for the state to an apparatus platform API of the electronic apparatus 100 by using the common application (S340, Y). The processor 130 acquires a state for each of the conditions through the apparatus platform API (S350).

If it is determined that the state for each of the conditions to execute the service application is acquired (S340, Y), based on the state of each of the conditions, the processor 130 determines whether each of the conditions to execute the service application is satisfied by using the common application (S360).

If there is an unsatisfied condition (S360, N), the processor 130 performs an operation to satisfy the condition by using the common application (S365). For example, if an adult authentication is not completed when the adult authentication is required to execute the service application to be executed, the processor 130 may control the display 120 to display a UI for the adult authentication by using the common application.

When all conditions to execute the service application are satisfied through the above mentioned procedure (S360, Y), the processor 130 determines whether an execution of the service application has succeeded by using the common application (S370). If the execution of the service application is failed (S370, N), the processor 130 may control the display 120 to display a pop-up error message by using the common application (S390). If the execution of the service application is succeeded (S370, Y), the service application is run (S380).

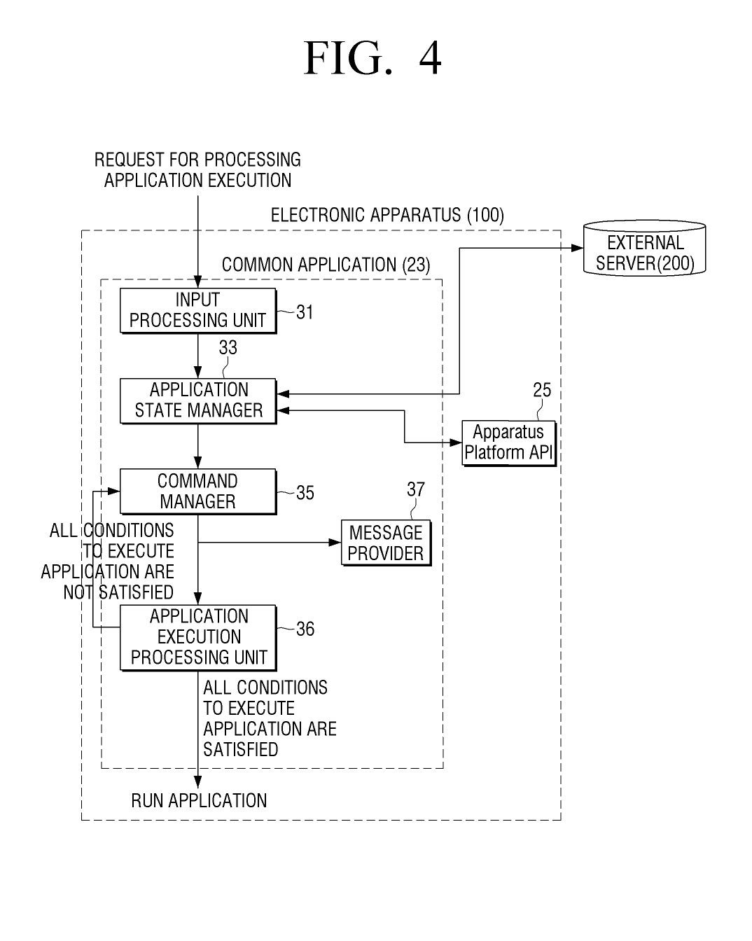

FIG. 4 is a diagram illustrating an example pre-processing function to execute an application by a common application in the electronic apparatus 100 according to an example embodiment.

Referring to FIG. 4, a common application 23 which uniformly performs pre-processing functions required to execute respective service applications is stored in the electronic apparatus 100.

For example, the common application 23 includes an input processing unit 31, an application state manager 33, a command manager 35, a message provider 37 and an application execution processing unit 36.

The input processing unit 31 of the common application 23 receives a request for executing a certain service application that a user input. The input processing unit 31 transmits an application ID of the service application to the application state manager 33.

The application state manager 33 transmits a request including the received application ID and information regarding an operating system (for example, Android, Tizen, etc.) of the electronic apparatus 100 to the external server 200. The external server 200 transmits information regarding a pre-processing procedure according to the request to the electronic apparatus 100. The information regarding the pre-processing procedure includes information of conditions required to execute the service application (a login requirement, a requirement for terms of use agreement, requirement for an adult authentication, etc) and an order in checking the conditions.

The application state manager 33 requests for result on determination whether each condition included in the information received from the external server 200 is satisfied to the apparatus platform API 25 and receives the result.

Based on the result received from the apparatus platform API 25, the application state manager 33 transmits a condition which should be satisfied to execute the service application to the command manager 35.

The command manager 35 performs an operation according to the condition which should be satisfied. The command manager 35 displays a UI screen for a login if a user is not logged in, a UI screen for a terms of use agreement, if the terms of use are not agreed, and a UI screen for an adult authentication, if an adult authentication is not completed, through the display 120.

If displaying a UI or executing an application fails, the command manager 35 transmits a reason code of a failure to the message provider 37. For example, if it is impossible to log in due to a network disconnection, the command manager 35 may transmit a reason code of the network disconnection to the message provider 37.

The message provider 37 may display a UI such as a pop-up guide message which is generated by decoding the reason code of the application execution failure received through the command manager 35, on the display 120. For example, a UI for a pop-up message may include the message “It cannot be logged in due to a network disconnection.”

The application execution processing unit 36 checks whether all conditions to execute the service application are satisfied. If not all of the conditions are satisfied, the application execution processing unit 36 requests to perform an operation according to an unsatisfied condition to the command manager 35 and when all of the conditions are satisfied, the service application is executed. As a result, an execution screen of the service application may be displayed on the display 120.

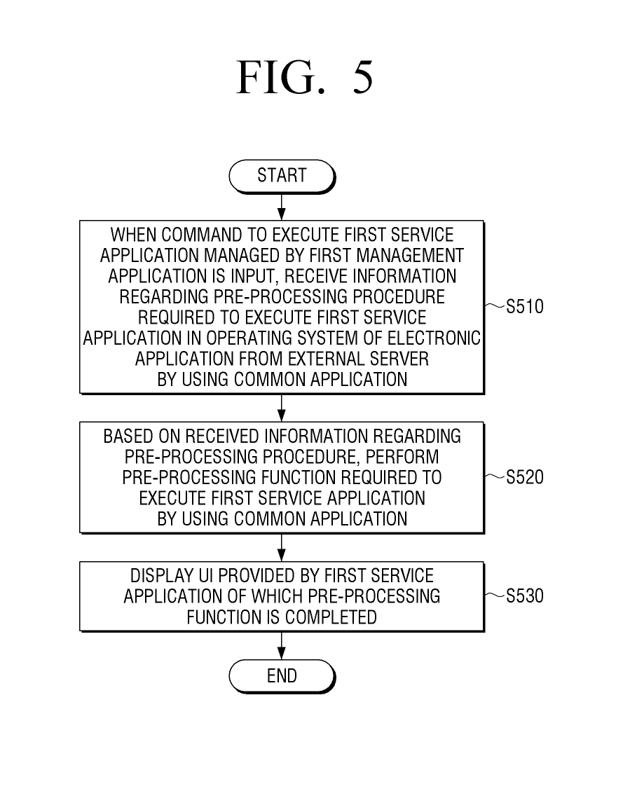

FIG. 5 is a flowchart illustrating an example method of controlling an electronic apparatus according to an example embodiment.

Herein, the electronic apparatus 100 includes an application which stores a plurality of management applications which manage a service application that provides a certain service and a common application which performs a pre-processing function required to execute the service application.

When a command to execute a first service application managed by a first management application among the plurality of management applications is input, the electronic apparatus 100 receives information regarding a pre-processing procedure required to execute the first service application in an operating system of the electronic apparatus 100 from an external server by using the common application (S510).

The electronic apparatus 100 performs the pre-processing function required to execute the first service application by using the common application based on the information regarding the pre-processing procedure received from the external service (S520).

The common application may perform pre-processing functions regarding service applications managed by different management applications. For example, a command to execute a second service application managed by a second management application among the plurality of management applications is input, the electronic apparatus 100 perform a pre-processing function required to execute the second service application by using the common application.

The common application may perform a pre-processing function for each application which is executed in a plurality of different operating systems. For example, if the electronic apparatus 100 is driven in a first operating system, information regarding a pre-processing procedure required to execute the first service application in the first operating system may be requested to and received from an external server, and if the electronic apparatus 100 is driven in a second operating system, information regarding a pre-processing procedure required to execute the first application in the second operating system to an external server may be requested to and received from the external server. Therefore, the electronic apparatus 100 may perform an appropriate pre-processing function to execute an application according to an operating system of the electronic apparatus 100 based on information received from the external server by using the common application.

Meanwhile, the electronic apparatus 100 may separately execute the management application and the common application. For example, when a command to execute the first service application is input through a UI provided by the first management application, the electronic apparatus 100 may check whether the common application is being executed and, if the common application is not being executed, the electronic apparatus 100 may execute the common application.

Herein, the plurality of management applications may respectively be an application which performs at least one of a function of downloading a new application and a function of executing another application in the management application.

The plurality of management applications may not include a service engine which performs the pre-processing function.

For example, the pre-processing function which is performed by using the common application may be at least one of a function of checking whether terms of use of a new application are agreed, a function of checking whether the first service application is installed in the electronic apparatus 100, a function of checking whether a user is logged into an account, a function of checking whether payment for the first service application is completed, a function of checking whether an adult authentication is completed for the first service application and a function of checking whether the first service application using a function of the electronic apparatus 100 is agreed.

The electronic apparatus 100 may check whether a condition for executing the first service application is satisfied by performing a pre-processing function by using the common application and display a UI according to an unsatisfied condition. For example, the conditions to execute the first service application relate to whether terms of use of a new application are agreed, whether the first service application is installed in the electronic apparatus, whether a user is logged into an account, whether payment for the first service application is completed, whether the first service application using a function of the electronic apparatus 100 is agreed and the like.

Meanwhile, the pre-processing function only pertains to an example. A different pre-processing function may be performed according to an attribute of an application to be executed or an operating system in which the application to be executed.

When the first service application cannot be executed due to a failure of executing the pre-processing function, the electronic apparatus 100 may display a guide UI for trying the execution of the first service application again by using the common application. The guide UI may include a button for trying the execution of the first service application again.

The electronic apparatus 100 displays a UI provide by the first service application of which the pre-processing function is completed (S530). For example, the UI provided by the first service application of which pre-processing function is completed may be a display which is displayed for the first time when the first service application is executed.

Meanwhile, the example embodiments may be embodied in a memory medium which can be read by a computer or the like using software, hardware or a combination thereof. By a hardware-based embodiment, the example embodiments may be embodied by using at least one of processing circuitry including Application Specific Integrated Circuits (ASICs), digital signal processors (DSPs), digital signal processing apparatuses (DSPDs), programmable logic apparatuses (PLDs), field programmable gate arrays (FPGAs), processors, controllers, micro-controllers, microprocessors and an electronic unit for performing another function. In some cases, the example embodiments may be embodied as the processor 130 itself. By a software-based embodiment, the procedures and functions explained in the example embodiments may be respectively embodied as separate software modules. Each of the software modules may perform at least one of the functions and operations explained in the disclosure.

Meanwhile, the method of controlling the electronic application according to the various example embodiments may be stored in a non-transitory readable medium. The non-transitory readable medium may be used by being installed in various apparatuses.

The non-transitory readable medium means a medium which stores a data semi-permanently and is readable by an apparatus, a memory and so on. For example, programs of performing the above-described various methods can be stored in a non-transitory computer readable medium such as a CD, a DVD, a hard disk, a Blu-ray disk, universal serial bus (USB), a memory card, ROM, or the like, and can be provided.

The foregoing example embodiments and advantages are merely examples and are not to be construed as limiting the present disclosure. The present teaching can be readily applied to other types of apparatuses. Also, the description of the example embodiments of the present disclosure is intended to be illustrative, and not to limit the scope of the claims, and many alternatives, modifications, and variations will be apparent to those skilled in the art.

What is claimed is:

1. An electronic apparatus, comprising:
a communicator comprising communication circuitry configured to communicate with an external server;
a storage configured to store a plurality of management applications to manage a service application configured to provide a certain service and a common application configured to perform a pre-processing function required to execute the service application;
a display configured to display a user interface (UI) provided by a first management application among the plurality of management applications; and
a processor configured to control the communication circuitry, in response to a command to execute a first service application managed by the first management application being input, to receive information regarding a pre-processing procedure required to execute the first service application in an operating system of the electronic apparatus from the external server using the common application, to perform a pre-processing function required to execute the first service application based on the received information on the pre-processing procedure, and to control the display to display a UI provided by the first service application of which the pre-processing function is completed.

2. The apparatus as claimed in claim 1, wherein the processor is configured to execute a pre-processing function required to execute a second service application using the common application, in response to a command to execute the second service application managed by a second management application among the plurality of management applications being input.

3. The apparatus as claimed in claim 1, wherein the plurality of management applications does not include a service engine performing the pre-processing function.

4. The apparatus as claimed in claim 1, wherein the plurality of management applications include an application configured to perform at least one of a function of downloading a new application and a function of executing another application in the application.

5. The apparatus as claimed in claim 1, wherein the pre-processing function includes at least one of: a function of checking whether terms of use of a new application is agreed, a function of checking whether the first service application is installed in the electronic apparatus, a function of checking whether a user is logged into an account, a function of checking whether payment for the first service application is completed, a function of checking whether an adult authentication is completed for the first service application and a function of checking whether the first service application using a function of the electronic apparatus is agreed.

6. The apparatus as claimed in claim 1, wherein the processor is configured to determine whether a condition for executing the first service application is satisfied by performing a pre-processing function using the common application and to control the display to display a UI according to an unsatisfied condition.

7. The apparatus as claimed in claim 1, wherein the processor is configured to control the display to display a guide UI for trying the first service application execution again using the common application, in response to the first service application being unable to be executed due to a failure of performing the pre-processing function.

8. The apparatus as claimed in claim 1, wherein the storage stores a plurality of operational programs corresponding to a plurality of operating systems, and
wherein the processor is configured to determine one of the plurality of operating systems as an operating system to be driven in the electronic apparatus based on a manipulation.

9. The apparatus as claimed in claim 8, wherein the processor is configured to control the communication circuitry to receive information regarding a pre-processing procedure required to drive the first service application in the determined operating system from the external server, in response to a command to execute the first service application being input in the determined operating system.

10. The apparatus as claimed in claim 1, wherein the processor is configured to separately execute the first management application and the common application.

11. The apparatus as claimed in claim 1, wherein the processor is configured to execute the common application, in response to a command to execute the first service application being input through a UI provided by the first management application.

12. A method of controlling an electronic apparatus storing a plurality of management applications to manage a service application which provides a certain service and a common application performing a pre-processing function required to execute the service application, the method comprising:
receiving information regarding a pre-processing procedure required to execute a first service application in an operating system of the electronic apparatus from an external server using the common application in response to a command to execute the first service application managed by the first management application being input among the plurality of management applications;
performing a pre-processing function required to execute the first service application using the common application based on the received information on the pre-processing procedure; and
displaying a UI provided by the first service application of which the pre-processing function is completed.

13. The method as claimed in claim 12, further comprising, executing a pre-processing function required to execute a second service application using the common application in response to a command to execute the second service application managed by a second management application among the plurality of management applications being input.

14. The method as claimed in claim 12, wherein the performing a pre-processing function includes determining whether a condition for executing the first service application is satisfied by performing a pre-processing function using the common application and displaying a UI based on an unsatisfied condition.

15. The method as claimed in claim 12, further comprising, displaying a guide UI for trying the first service application execution again using the common application in response to the first service application being unable to be executed due to a failure of performing the pre-processing function.

16. The method as claimed in claim 12, further comprising;
storing a plurality of operational programs corresponding to a plurality of operating systems by the electronic apparatus, and
determining one of the plurality of operating systems as an operating system to be driven in the electronic apparatus based on a manipulation.

17. The method as claimed in claim 16, wherein the receiving includes, receiving information regarding a pre-processing procedure required to drive the first service application in the determined operating system from the external server in response to a command to execute the first service application being input in the determined operating system.

18. The method as claimed in claim 12, wherein the first management application and the common application are separately executed.

19. The method as claimed in claim 12, further comprising:
displaying a UI provided by the first management application; and
executing the common application in response to a command to execute the first service application being input through the UI.

20. A non transitory computer-readable recording medium having a program stored thereon to execute a method of controlling an electronic apparatus storing a plurality of management applications to manage a service application which provides a certain service and a common application performing a pre-processing function required to execute the service application, the program, when executed, causing a processor to perform operations of a method of controlling and electronic apparatus, the method comprising:
receiving information regarding a pre-processing procedure required to execute a first service application in an operating system of the electronic apparatus from an external server using the common application in response to a command to execute a first service application managed by the first management application being input among the plurality of management applications;
performing a pre-processing function required to execute the first service application using the common application based on the received information on the pre-processing procedure; and
displaying a UI provided by the first service application of which the pre-processing function is completed.
